(19) United States
(12) Patent Application Publication
(10) Pub. No.: US 2007/0289831 A1
(43) Pub. Date: Dec. 20, 2007

(54) Power transmission mechanism

(76) Inventors: Masaki Ota, Kariya-shi (JP); Masahiro Kawaguchi, Kariya-shi (JP)

Correspondence Address: MORGAN & FINNEGAN, L.L.P., 3 WORLD FINANCIAL CENTER, NEW YORK, NY, 10281-2101, US

(21) Appl. No.: 11/818,069

(22) Filed: Jun. 12, 2007

(30) Foreign Application Priority Data
Jun. 15, 2006 (JP) P2006-166323

(51) Int. Cl. F16D 41/06; F16D 15/00; H02K 1/12

(52) U.S. Cl. 192/38; 310/254; 192/44

(57) ABSTRACT

A power transmission mechanism for transmitting power of an external drive source to a rotary shaft which is rotatably supported by a housing of a rotary machine comprises a first rotor fixed to the rotary shaft for rotation therewith, a second rotor rotatably supported by the housing for receiving the power of the external drive source, and a spring clutch disposed over first and second outer peripheral surfaces of the first and second rotors which are aligned with each other along an axial direction of the rotary shaft. The spring clutch is mounted at one end to the first rotor and at the other end to an armature. The spring clutch tightens the first and second outer peripheral surfaces thereby to connect the first and second rotors when the armature is attracted to the second rotor.

### BACKGROUND OF THE INVENTION

The present invention relates to a power transmission mechanism which transmits power from an external drive source to a rotary shaft.

There has existed a refrigerant compressor of a vehicle air-conditioner which has a power transmission mechanism 100 for transmitting power of a vehicle engine to the rotary shaft of the compressor as shown in FIG. 5 (cf. Japanese Utility Model Application Publication No. 62-16836). In the refrigerant compressor, a rotor 102 is rotatably supported outside the housing 101 of the compressor through a radial bearing 103. A magnetic coil 104 and a magnetic member 105 having a permanent magnet are disposed in the rotor 102. A hub 107 is fixed to the outer end of the rotary shaft 106 of the refrigerant compressor, and an armature 109 is supported by the hub 107 through a leaf spring 108. The armature 109 is disposed so as to face the rotor 102 with a predetermined spaced interval therebetween.

For transmitting the power of the vehicle engine to the rotary shaft 106 of the refrigerant compressor by the power transmission mechanism 100, electric current is supplied to the magnetic coil 104, that is, the magnetic coil 104 is energized thereby to attract the armature 109 to the rotor 102. Then, the electric current supply to the magnetic coil 104 is stopped, that is, the magnetic coil 104 is de-energized. At this time, a magnetic flux path is formed by the permanent magnet between the armature 109 and the rotor 102 thereby to keep the armature 109 attracted to the rotor 102. After the magnetic coil 104 is de-energized, the power of the vehicle engine continues to be transmitted to the armature 109 through the rotor 102 and further to the rotary shaft 106 through the leaf spring 108 and the hub 107.

In the above-described power transmission mechanism 100, the magnetic flux path which has been formed in energizing the magnetic coil 104 is maintained after the magnetic coil 104 is de-energized, thus the armature 109 being kept attracted to the rotor 102 for transmission of the power of vehicle engine to the rotary shaft of the compressor. In order to increase the power to be transmittable from the rotor 102 to the armature 109 after de-energization of the magnet coil 104, the power transmission mechanism 100 needs to be modified so as to make it hard for the armature 109 to be separated from the rotor 102. This may be accomplished, for example, by making the permanent magnet larger in size thereby to increase the magnetic flux density in the magnetic flux path or by enlarging the contact area between the rotor 102 and the armature 109 thereby to increase the frictional force therebetween, which will only make the power transmission mechanism 100 large in size.

The present invention is directed to a power transmission mechanism which is capable of increasing the transmittable power after de-energization of the magnetic coil without being made large in size.

### SUMMARY OF THE INVENTION

An aspect in accordance with the present invention provides a power transmission mechanism for transmitting power of an external drive source to a rotary shaft which is rotatably supported by a housing of a rotary machine. The power transmission mechanism comprises a first rotor, an elastic member, an armature, a second rotor, a magnetic coil, a permanent magnet, and a spring clutch. The first rotor is fixed to the rotary shaft for rotation therewith and has a first outer peripheral surface. The elastic member is fixed to the first rotor, and the armature is supported by the elastic member. The second rotor is rotatably supported by the housing for receiving the power of the external drive source. The second rotor faces the armature with a space therebetween. The second rotor is coaxial with the first rotor and has a second outer peripheral surface adjacent to the first outer peripheral surface. The first and second outer peripheral surfaces are aligned with each other along an axial direction of the rotary shaft. The magnetic coil is loosely disposed in the second rotor. The permanent magnet is provided between the magnetic coil and the armature. The armature is attracted to the second rotor against an elastic force of the elastic member by energizing the magnetic coil. The armature is kept attracted to the second rotor by the permanent magnet to connect the first and second rotors after de-energization of the magnetic coil, thereby transmitting the power of the external drive source to the rotary shaft. The spring clutch is disposed over the first and second outer peripheral surfaces. The spring clutch is mounted at one end to the first rotor and at the other end to the armature. The spring clutch tightens the first and second outer peripheral surfaces thereby to connect the first and second rotors when the armature is attracted to the second rotor.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a longitudinal cross-sectional view of a refrigerant compressor of a preferred embodiment according to the present invention;

FIG. 2 a partially enlarged cross-sectional view of the refrigerant compressor of the preferred embodiment according to the present invention showing an electromagnetic clutch;

FIG. 3 a partially enlarged cross-sectional view of the refrigerant compressor of the preferred embodiment according to the present invention when the electromagnetic clutch is in a connected state;

FIG. 4 a partially enlarged cross-sectional view of the refrigerant compressor of an alternative embodiment according to the present invention showing an electromagnetic clutch; and

FIG. 5 a partially enlarged cross-sectional view of a refrigerant compressor of the background art showing a power transmission mechanism.

### DETAILED DESCRIPTION OF THE PREFERRED EMBODIMENTS

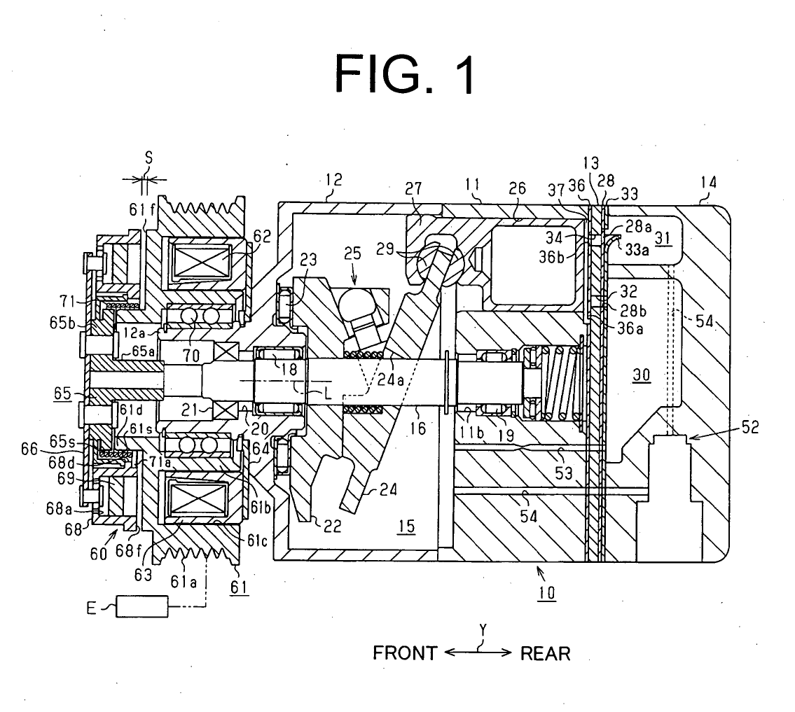

The following will describe a preferred embodiment of power transmission mechanism according to the present invention with reference to FIGS. 1 through 3, in which the present invention is applied to a refrigerant compressor for a vehicle air-conditioner. In the following description, the front and the rear of the refrigerant compressor 10 are indicated by the double-headed arrow Y in FIG. 1.

Referring to FIG. 1, the refrigerant compressor 10 as a rotary machine has a housing assembly which includes a cylinder block 11, a front housing 12 and a rear housing 14. The front housing 12 is joined to the front end of the cylinder block 11, and the rear housing 14 is joined to the rear end of the cylinder block 11. Between the cylinder block 11 and the rear housing 14 are interposed a suction valve plate 36, a valve plate 13, a discharge valve plate 28 and a retainer plate 33.

The cylinder block 11 and the front housing 12 cooperate to define therebetween a pressure-control chamber 15, through which a rotary shaft 16 extends. The rotary shaft 16 is rotatably supported by the cylinder block 11 and the front housing 12. The front housing 12 has at the front end thereof a support cylinder 12a which is formed to surround the front portion of the rotary shaft 16. The front end of the rotary shaft 16 extends out of the housing assembly from the support cylinder 12a and is operatively connected to a vehicle engine E as an external drive source through an electromagnetic clutch 60.

The rotary shaft 16 is rotatably supported at the front portion thereof by the front housing 12 through a radial bearing 18. A shaft seal chamber 20 is formed in the front housing 12 between the outer peripheral surface of the front portion of the rotary shaft 16 and the inner peripheral surface of the front housing 12 which faces the outer peripheral surface of the front portion of the rotary shaft 16. A shaft seal member 21 is provided between the rotary shaft 16 and the support cylinder 12a of the front housing 12 in the shaft seal chamber 20 for sealing the rotary shaft 16. The rotary shaft 16 is inserted at the rear portion thereof in a shaft hole 11b which is formed in the cylinder block 11, and rotatably supported at the rear portion thereof by the cylinder block 11 through a radial bearing 19.

In the pressure-control chamber 15, a lug plate 22 is secured to the rotary shaft 16 for rotation therewith, and a thrust bearing 23 is provided between the lug plate 22 and the inner wall surface of the front housing 12. A swash plate 24 is disposed in the pressure-control chamber 15 and has at the center thereof a hole 24a through which the rotary shaft 16 is inserted so that the swash plate 24 is supported by the rotary shaft 16 through the hole 24a. A hinge mechanism 25 is interposed between the swash plate 24 and the lug plate 22, and the swash plate 24 is connected to the lug plate 22 through the hinge mechanism 25. Such arrangement permits the swash plate 24 to rotate synchronously with the lug plate 22 and the rotary shaft 16 and to incline with respect to the rotary shaft 16 while sliding in the direction of the central axis L of the rotary shaft 16.

The cylinder block 11 has formed therein a plurality of cylinder bores 26 (only one cylinder bore being shown in FIG. 1) which are arranged around the rotary shaft 16 at equiangular intervals and extend in the direction of the central axis L of the rotary shaft 16. Each cylinder bore 26 receives therein a single-headed piston 27 for reciprocation. The front and rear openings of each cylinder bore 26 are closed by the piston 27 and the suction valve plate 36, respectively, so that a compression chamber 37 is defined in the cylinder bore 26. The volume of the compression chamber 37 varies in accordance with the reciprocation of the piston 27. The piston 27 engages with the outer peripheral portion of the swash plate 24 through a pair of shoes 29.

In the rear housing 14, a suction chamber 30 and a discharge chamber 31 are defined so as to face the retainer plate 33. More specifically, the discharge chamber 31 is provided in the middle of the rear housing 14, and the suction chamber 30 is provided radially outward of the discharge chamber 31. The valve plate 13 has formed therethrough suction ports 32 which are located at positions corresponding to the compression chambers 37, respectively. The valve plate 13 also has formed therethrough discharge ports 34 which are located radially outward of the respective suction ports 32.

The suction valve plate 36 has suction valves 36a which are located at positions corresponding to the suction ports 32, respectively, for opening and closing the suction ports 32. The suction valve plate 36 has formed therethrough discharge holes 36b which are located at positions corresponding to the discharge ports 34, respectively. The discharge valve plate 28 has discharge valves 28a which are located at positions corresponding to the discharge ports 34, respectively, for opening and closing the discharge ports 34. The discharge valve plate 28 has formed therethrough suction holes 28b which are located at positions corresponding to the suction ports 32, respectively. The retainer plate 33 has retainers 33a for restricting the opening of the discharge valves 28a. In the rear housing 14, an electromagnetically-operated displacement control valve 52 is installed.

As the piston 27 moves from its top dead center toward its bottom dead center, refrigerant gas in the suction chamber 30 is drawn into the compression chamber 37 through the suction hole 28b and the suction port 32 while pushing open the suction valve 36a. As the piston 27 moves from its bottom dead center toward its top dead center, on the other hand, the refrigerant gas in the compression chamber 37 is compressed and then discharged into the discharge chamber 31 through the discharge hole 36b and the discharge port 34 while pushing open the discharge valve 28a. The high-pressure refrigerant gas in the discharge chamber 31 flows out to an external refrigerant circuit (not shown). Then, the refrigerant gas returns from the external refrigerant circuit to the suction chamber 30 of the compressor 10. In the preferred embodiment, the refrigerant compressor 10 forms a refrigerant circulation circuit together with the external refrigerant circuit. The cylinder block 11 (the cylinder bores 26), the rotary shaft 16, the lug plate 22, the swash plate 24, the hinge mechanism 25, the pistons 27, and the shoes 29 constitute a compression unit of the refrigerant compressor 10, which is driven by the rotation of the rotary shaft 16.

The refrigerant compressor 10 has a supply passage 54 which connects the discharge chamber 31 as a discharge-pressure region to the pressure-control chamber 15 for supplying the refrigerant gas in the discharge chamber 31 as control gas to the pressure-control chamber 15. The aforementioned displacement control valve 52 is arranged in the supply passage 54. The refrigerant compressor 10 also has a bleed passage 53 which connects the pressure-control chamber 15 to the suction chamber 30 as a suction-pressure region for the refrigerant gas in the pressure-control chamber 15 to be drawn to the suction chamber 30. Part of the refrigerant gas discharged into the discharge chamber 31 is supplied to the pressure-control chamber 15 through the supply passage 54. The amount of the refrigerant gas which is supplied to the pressure-control chamber 15 through the supply passage 54 is adjusted by the displacement control valve 52.

The refrigerant gas in the pressure-control chamber 15 is drawn to the suction chamber 30 through the bleed passage 53. The pressure in the pressure-control chamber 15 is adjusted or determined by controlling the balance between the amount of the refrigerant gas which is supplied from the discharge chamber 31 to the pressure-control chamber 15 through the supply passage 54 and the amount of the refrigerant gas which is drawn from the pressure-control chamber 15 to the suction chamber 30 through the bleed passage 53. As the pressure in the pressure-control chamber 15 is changed, the differential pressure between the pressure-control chamber 15 and the cylinder bore 26 across the piston 27 is varied thereby to change the inclination angle of the swash plate 24. Thus, the stroke of the piston 27 and hence the displacement of the refrigerant compressor 10 is adjusted.

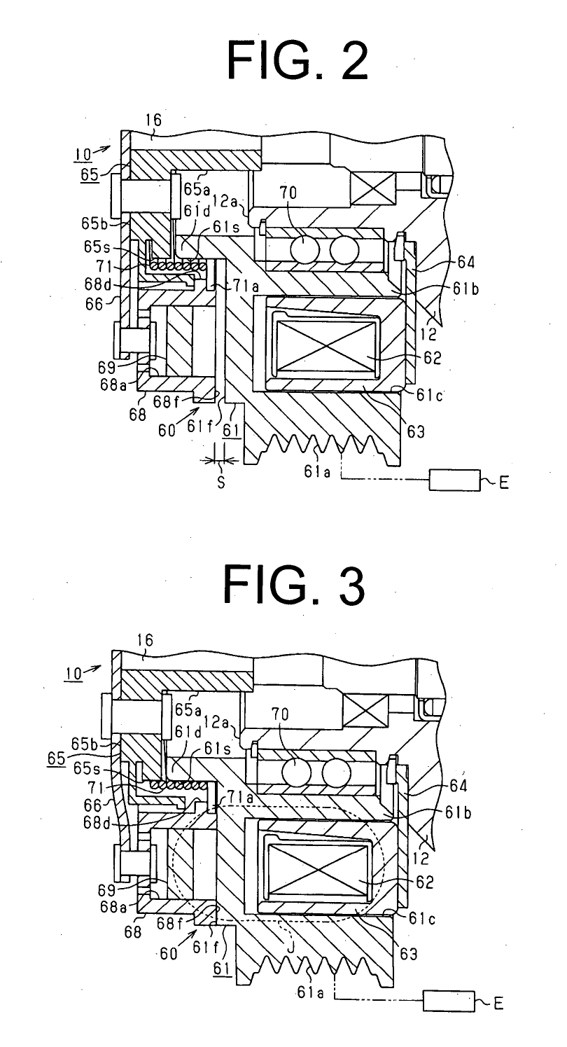

The following will describe the electromagnetic clutch 60 in detail. Referring to FIGS. 1 and 2, a cylindrical rotor 61 as a second rotor is rotatably supported on the support cylinder 12a of the front housing 12 through a radial bearing 70. The rotor 61 is made of a magnetic material and has a pulley portion 61a and a cylindrical support portion 61b which is provided radially inward of the pulley portion 61a. The pulley portion 61a and the cylindrical support portion 61b are formed integral with each other and a drive belt (not shown) is installed between the pulley portion 61a and the output shaft of the vehicle engine E. The rotor 61 is rotatably supported at the support portion 61b thereof by the support cylinder 12a of the front housing 12 through the radial bearing 70.

The rotor 61 has an annular recess 61c which is formed between the inner peripheral surface of the pulley portion 61a and the outer peripheral surface of the support portion 61b for receiving therein a cylindrical case 63 which accommodates therein a magnetic coil 62 made of a magnetic material. The cylindrical case 63 is supported by an annular support member 64 which is supported by the outer periphery of the support cylinder 12a of the front housing 12. With the cylindrical case 63 supported by the support member 64, a narrow clearance is formed between the inner surface of the recess 61c (or the inner peripheral surface of the pulley portion 61a and the outer peripheral surface of the support portion 61b) and the outer peripheral surface of the cylindrical case 63 which faces the inner surface of the recess 61c. Thus, the cylindrical case 63 having therein the magnetic coil 62 is loosely disposed in the recess 61c of the rotor 61 so that the magnetic coil 62 will not rotate with the rotor 61. The rotor 61 has a cylindrical portion 61d which extends frontward along the central axis L of the rotary shaft 16 further than the support cylinder 12a of the front housing 12. The magnetic coil 62 is so configured that electric current can be supplied thereto selectively in normal direction and in reverse direction.

An armature hub 65 as a first rotor is fixed to the front end of the rotary shaft 16 for rotation therewith. The armature hub 65 has a cylindrical portion 65a which is fitted over the front end portion of the rotary shaft 16 and a hub portion 65b which extends from the cylindrical portion 65a in the direction perpendicular to the axial direction of the rotary shaft 16. It is noted that the cylindrical portion 65a of the armature hub 65 is engaged with the rotary shaft 16 in the rotation direction of the rotary shaft 16 by means of spline, key or the like. The surface of the hub portion 65b on the side of the front housing 12 (or the rear end surface) faces the surface of the cylindrical portion 61d on the side of the armature hub 65 (or the front end surface). The hub portion 65b has an outer peripheral surface 65s adjacent to the cylindrical portion 61d. The cylindrical portion 61d has an outer peripheral surface 61s adjacent to the outer peripheral surface 65s. These outer peripheral surfaces 65s, 61s are aligned with each other in the axial direction of the rotary shaft 16, coaxial with each other and have substantially the same diameter.

A leaf spring 66 as an elastic member is fixed to the front end surface of the armature hub 65. The leaf spring 66 has a free end to which an armature 68 of a magnetic material is mounted. The armature 68 is supported by the armature hub 65 through the leaf spring 66 at a position that faces the rotor 61. The armature 68 has a recess 68a on the side thereof adjacent to the rotor 61. A permanent magnet 69 is fitted in the recess 68a between the armature 68 and the rotor 61.

When electric current is supplied to the magnetic coil 62 in normal direction, the permanent magnet 69 generates magnetic flux in normal direction. When electric current is supplied to the magnetic coil 62 in reverse direction, the permanent magnet 69 generates magnetic flux in reverse direction. The armature 68 has a frictional surface 68f which faces the rotor 61 and the rotor 61 has a frictional surface 61f which faces the frictional surface 68f with a space S formed between the frictional surfaces 61f and 68f. The leaf spring 66 urges the armature 68 by its elastic force in the direction which causes the frictional surface 68f to be moved away from the frictional surface 61f.

In the electromagnetic clutch 60, a spring clutch 71 in the form of a coil spring is disposed over the outer peripheral surface 65s of the hub portion 65b and the outer peripheral surface 61s of the cylindrical portion 61d. In other words, the spring clutch 71 is provided in the space which is defined by the outer peripheral surface 65s of the hub portion 65b, the outer peripheral surface 61s of the cylindrical portion 61d, and the inner peripheral surface 68d of the armature 68. Specifically, the spring clutch 71 is mounted at one end thereof to the hub portion 65b of the armature hub 65 and at the other end 71a thereof to the armature 68.

When the electromagnetic clutch 60 is disengaged, that is, when the rotor 61 is disconnected from the armature 68, the diameter of the spring clutch 71 is larger than those of the outer peripheral surface 65s of the hub portion 65b and the outer peripheral surface 61s of the cylindrical portion 61d. Thus, the spring clutch 71 is spaced away from the outer peripheral surfaces 61s and 65s. When the electromagnetic clutch 60 is engaged, that is, when the rotor 61 is connected to the armature 68, the diameter of the spring clutch 71 is reduced so that the spring clutch 71 is tightly fitted on the outer peripheral surface 61s and 65s.

The following will describe the operation of the electromagnetic clutch 60. When the electric current is supplied to the magnetic coil 62 in normal direction in FIG. 2 thereby to energize the magnetic coil 62, attraction force caused by the electromagnetic force of the magnetic coil 62 is produced to attract the armature 68 toward the magnetic coil 62. Then, as shown in FIG. 3, the armature 68 is moved to the rotor 61 against the elastic force of the leaf spring 66, so that the frictional surface 68f of the armature 68 is brought into press contact with the frictional surface 61f of the rotor 61. In this state, the rotor 61 is connected to the armature 68, that is, the rotor 61 is connected to the armature hub 65 through the leaf spring 66.

Since the spring clutch 71 is mounted at the other end 71a thereof to the armature 68, the spring clutch 71 is stretched as the armature 68 is moved toward the rotor 61, so that the diameter of the spring clutch 71 is reduced. Thus, the spring clutch 71 is constricted thereby to tighten the outer peripheral surface 65s of the armature hub 65 and the outer peripheral surface 61s of the rotor 61, thus connecting the hub portion 65b to the cylindrical portion 61d. As a result, the rotor 61 and the armature hub 65 are coupled together securely by the electromagnetic attraction force of the magnetic coil 62 and the tightening force of the spring clutch 71.

With the rotor 61 connected to the armature 68, a magnetic flux path J which flows in normal direction is generated between the rotor 61 and the armature 68. The armature 68 is attracted to the rotor 61 by the magnetic flux path J and a frictional force is created between the frictional surfaces 61f and 68f, accordingly, which serves to maintain the connection of the rotor 61 to the armature 68. With the above connection maintained, the spring clutch 71 is kept stretched to tighten the outer peripheral surface 65s of the hub portion 65b and the outer peripheral surface 61s of the cylindrical portion 61d. After the electric current supply to the magnetic coil 62 in normal direction is stopped to de-energize the magnetic coil 62, the connected state of the electromagnetic clutch 60 is maintained by the electromagnetic attraction force of the permanent magnet 69 and the tightening force of the spring clutch 71. Therefore, the power of the vehicle engine E is transmitted to the rotary shaft 16 through the electromagnetic clutch 60.

When electric current is supplied to the magnetic coil 62 in reverse direction, on the other hand, magnetic flux is generated in the direction which is reverse to that when the electric current is supplied in normal direction and cancels the magnetic flux in normal direction. The armature 68 is moved away from the rotor 61 by the elastic force of the leaf spring 66, and the electromagnetic clutch 60 is disengaged. Therefore, the rotor 61 is disconnected from the armature 68 or from the armature hub 65, and the power of the vehicle engine E is not transmitted any more to the rotary shaft 16.

According to the preferred embodiment described above, the following advantageous effects are obtained.

(1) The electromagnetic clutch 60 has the spring clutch 71, in addition to the power transmission mechanism which includes the magnetic coil 62, the permanent magnet 69, and the armature 68. When electric current is supplied to the magnetic coil 62 in normal direction, the armature 68 is attracted to the rotor 61 and the spring clutch 71 tightens the rotor 61 and the armature hub 65 for connection of the rotor 61 to the armature 68. After de-energization of the magnetic coil 62, the connection of the rotor 61 to the armature 68 is maintained by the magnetic flux path J from the permanent magnet 69 and the tightening by the spring clutch 71 is also maintained. That is, after de-energization of the magnetic coil 62, the power remains to be transmitted with the rotor 61 connected to the armature 68 by the magnetic flux path J and the rotor 61 connected to the armature hub 65 by the spring clutch 71. Therefore, after de-energization of the magnetic coil 62, the connecting force of the electromagnetic clutch 60 can be increased as compared to the case when the rotor 61 is connected to the armature 68 only by the magnetic flux path J from the permanent magnet 69. Thus, the electromagnetic clutch 60 can increase the power for transmission from the vehicle engine E to the rotary shaft 16. As a result, the magnetic flux density in the magnetic flux path J does not have to be increased by making the permanent magnet 69 larger in size, or the frictional force does not have to be increased by enlarging the frictional surfaces 61f and 68f, for increasing the power which is transmittable by the electromagnetic clutch 60 after de-energization of the magnetic coil 62. Thus, the power which is transmittable by the electromagnetic clutch 60 can be increased without making the electromagnetic clutch 60 large in size.

### (2) The provision of only the spring clutch 71 to the power transmission mechanism which uses the permanent magnet 69 increases the power which is transmittable by the power transmission mechanism after de-energization of the magnetic coil 62.

(3) Because the permanent magnet 69 is disposed in the armature 68, only one magnetic flux path J is generated between the armature 68 and the rotor 61 when the armature 68 is attracted to the rotor 61. In the case where a permanent magnet is disposed in the rotor, two magnetic flux paths are generated between the armature and the rotor and between the permanent magnet and the rotor when the armature is attracted to the rotor, and, therefore, the magnetic flux density in the magnetic flux paths is decreased. Unlike such a case, the magnetic flux density in the magnetic flux path is prevented from being decreased in the preferred embodiment. This also prevents a decrease of the attraction force which is caused by the magnetic flux path J from permanent magnet 69 and attracts the armature 68 to the rotor 61, and contributes significantly to increasing the power which is transmittable by the electromagnetic clutch 60 after de-energization of the magnetic coil 62.
(4) The permanent magnet 69 which is disposed in the armature 68 is located away further from the refrigerant compressor 10 than a magnet which is disposed in the rotor 61. Thus, the permanent magnet 69 is less susceptible to the heat which is generated at the radial bearing 70 in the refrigerant compressor 10 and also to the heat which is generated during the operation of the refrigerant compressor 10. Such arrangement of the magnet 69 serves to prevent the magnet from being demagnetized by the above heats and hence decreasing the force which attracts the armature 68 to the rotor 61, thus contributing significantly to increasing the power which is transmittable by the electromagnetic clutch 60 after de-energization of the magnetic coil 62.
(5) The spring clutch 71 is disposed between the outer peripheral surfaces 65s, 61s of the hub portion 65b and the cylindrical portion 61d and the inner peripheral surface 68d of the armature 68 which faces the outer peripheral surfaces 61s and 65s. That is, the spring clutch 71 is provided radially inward of the electromagnetic clutch 60, or in a space which is formed in constructing the electromagnetic clutch 60. Thus, the electromagnetic clutch 60 will not be made larger in size by the addition of the spring clutch 71, unlike the case where an additional structure is provided to the electromagnetic clutch 60 in order to increase the power which is transmittable by the electromagnetic clutch 60.

The above preferred embodiment may be modified as follows.

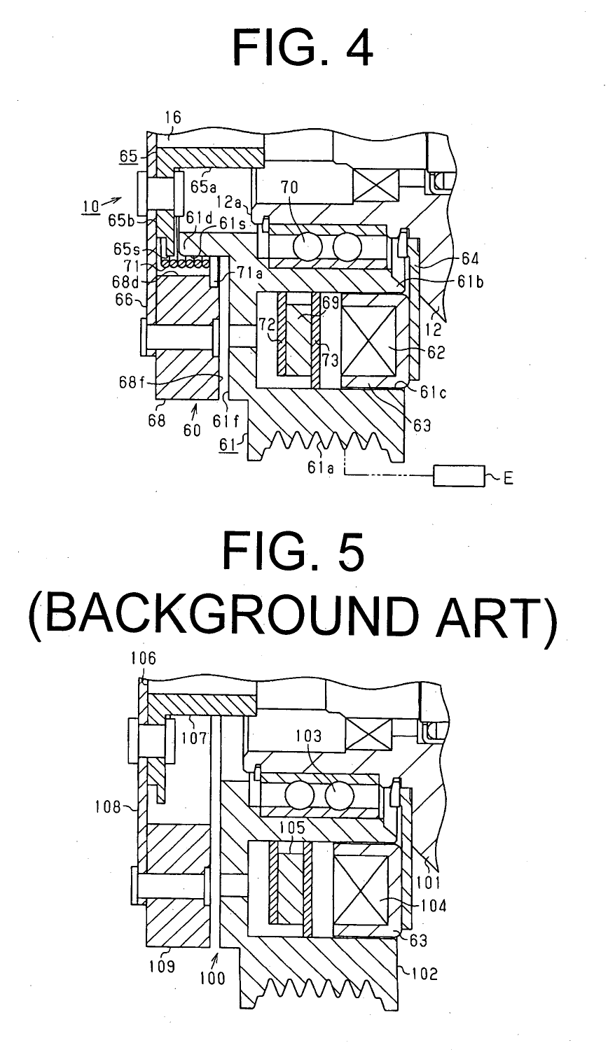

In the electromagnetic clutch 60 shown in FIG. 4, the permanent magnet 69 is disposed in the rotor 61. In this case, magnetic plates 72 and 73 are fitted in the recess 61c of the rotor 61, and the permanent magnet 69 is interposed between the magnetic plates 72 and 73.

The permanent magnet 69 may be configured so as to generate magnetic flux in the direction reverse to that in the above-described preferred embodiment. More specifically, when electric current is supplied to the magnetic coil 62 in reverse direction, the permanent magnet 69 generates magnetic flux in normal direction thereby to attract the armature 68 to the rotor 61, thus causing the electromagnetic clutch 60 to be engaged. When electric current is supplied to the magnetic coil 62 in normal direction, the permanent magnet 69 generates magnetic flux in reverse direction thereby to move the armature 68 away from the rotor 61, thus causing the electromagnetic clutch 60 to be disengaged.

In the above preferred embodiment, the refrigerant compressor 10 is of a single-headed piston type in which the single-headed piston 27 performs compression. Alternatively, the refrigerant compressor 10 may be changed to double-headed piston type in which a double-headed piston performs compression in cylinder bores which are formed in a cylinder block on both sides of the pressure-control chamber 15.

In the above preferred embodiment, the refrigerant compressor 10 has the swash plate 24 which is rotatable with the rotary shaft 16. Alternatively, the refrigerant compressor 10 may be changed to a type in which a cam plate is supported so as to be rotatable relative to the rotary shaft 16 with a wobbling motion, such as wobble type.

The refrigerant compressor 10 may be of a fixed displacement type in which the stroke length of the piston 27 is unchanged.

The above preferred embodiment has been described for the piston type refrigerant compressor 10, as a rotary machine, in which the piston 27 reciprocates. It is noted that the present invention is applicable to any rotary machine as long as power from any external drive source is transmitted to the rotary machine through an electromagnetic clutch.

A sprocket, a gear or the like may be used as a second rotor instead of the rotor 61.

A closure member may be mounted for partially closing the recess 68a of the armature 68, and an annular groove may be formed in the closure member for diverting magnetic flux. An annular groove may be formed in the frictional surface 61f of the rotor 61 at a position which dose not face the annular groove in the closure member for diverting magnetic flux.

Therefore, the present examples and embodiments are to be considered as illustrative and not restrictive, and the invention is not to be limited to the details given herein but may be modified within the scope of the appended claims.

What is claimed is:

1. A power transmission mechanism for transmitting power of an external drive source to a rotary shaft which is rotatably supported by a housing of a rotary machine, comprising:
a first rotor fixed to the rotary shaft for rotation therewith, the first rotor having a first outer peripheral surface;
an elastic member fixed to the first rotor;
an armature supported by the elastic member;
a second rotor rotatably supported by the housing for receiving the power of the external drive source, the second rotor facing the armature with a space therebetween, the second rotor being coaxial with the first rotor, the second rotor having a second outer peripheral surface adjacent to the first outer peripheral surface, the first and second outer peripheral surfaces being aligned with each other along an axial direction of the rotary shaft;
a magnetic coil loosely disposed in the second rotor;
a permanent magnet provided between the magnetic coil and the armature, wherein the armature is attracted to the second rotor against an elastic force of the elastic member by energizing the magnetic coil, and the armature is kept attracted to the second rotor by the permanent magnet to connect the first and second rotors after de-energization of the magnetic coil, thereby transmitting the power of the external drive source to the rotary shaft; and
a spring clutch disposed over the first and second outer peripheral surfaces, the spring clutch being mounted at one end to the first rotor and at the other end to the armature, the spring clutch tightening the first and second outer peripheral surfaces thereby to connect the first and second rotors when the armature is attracted to the second rotor.

2. The power transmission mechanism according to claim 1, wherein the permanent magnet is disposed in the armature.

3. The power transmission mechanism according to claim 1, wherein the spring clutch is disposed between the first and second outer peripheral surfaces and an inner peripheral surface of the armature which faces the first and second outer peripheral surfaces.

4. The power transmission mechanism according to claim 1, wherein the permanent magnet is disposed in the second rotor.

5. The power transmission mechanism according to claim 1, wherein the first rotor is an armature hub which is fixed to an end of the rotary shaft.

6. The power transmission mechanism according to claim 1, wherein the elastic member is a leaf spring.

7. The power transmission mechanism according to claim 1, wherein the second rotor has a cylindrical portion for forming the second outer peripheral surface.

8. The power transmission mechanism according to claim 1, wherein the spring clutch is stretched so that a diameter thereof is reduced to tighten the first and second outer peripheral surfaces when the armature is attracted to the second rotor.

9. A rotary machine comprising a rotary shaft and a power transmission mechanism according to claim 1.

10. The rotary machine according to claim 9, further comprising a compression unit driven by rotation of the rotary shaft.

11. The rotary machine according to claim 9, wherein the rotary machine is a compressor.
